(19) United States
(12) Patent Application Publication
(10) Pub. No.: US 2026/0097689 A1
(43) Pub. Date: Apr. 9, 2026

(54) FOAM SEAT CUSHION WITH TRIM AND SENSOR ATTACHMENTS

(71) Applicant: LEAR CORPORATION, Southfield, MI (US)

(72) Inventors: Erdal Kuscu, Sindelfingen (DE); Raphael Markert, Southfield, MI (US); Urszula Bebenek, Southfield, MI (US); Jaime Dorta Alvarez, Southfield, MI (US)

(21) Appl. No.: 18/908,984

(22) Filed: Oct. 8, 2024

(51) Int. Cl. B60N 2/00; B60N 2/58; B60N 2/64

(52) U.S. Cl. CPC B60N 2/0033; B60N 2/58; B60N 2/64

(57) ABSTRACT

A seat cushion includes a foam body comprising a first surface and a second surface facing opposite the first surface. A plurality of protrusions extend outwardly of at least one of the first surface and the second surface, and a plurality of cutouts are spaced from the plurality of protrusions. Each cutout extends through a thickness of the foam body from the first surface to the second surface, and at least one cutout is associated with at least one of a sensor and a trim component.

### BACKGROUND

A vehicle seat may include seat bottom and seat back support structures that comprise foam cushions.

### BRIEF DESCRIPTION OF THE DRAWINGS

FIG. 1 is a perspective view of an example seat.

FIG. 2 is a B-side view of a foam body for a seat cushion.

FIG. 3 is an enlarged view of a central portion of the seat cushion of FIG. 2.

FIG. 4 is a view of an opposite side of the seat cushion of FIG. 3.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to a foam seat cushion that includes a plurality of strengthening members and a plurality of cutout portions for attaching trim and sensors, wherein the cutouts are arranged in predetermined relation to the strengthening members.

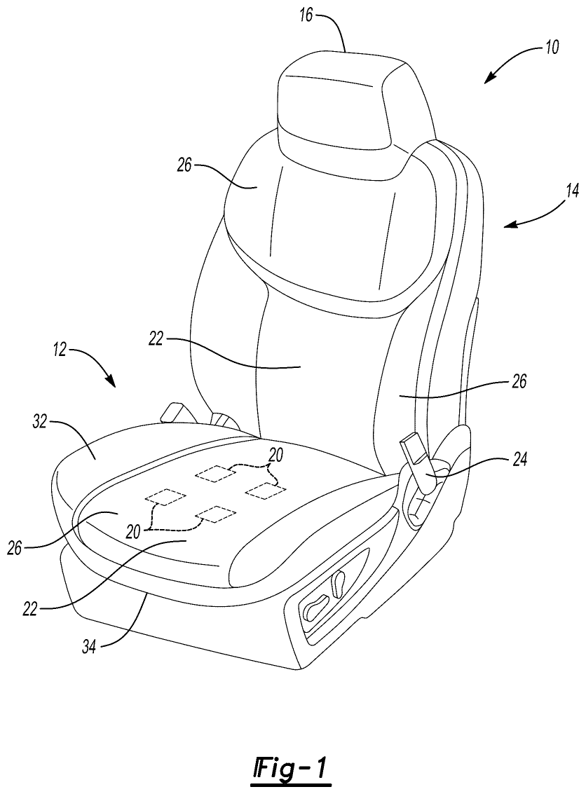

FIG. 1 illustrates a seat assembly 10 according to one example embodiment. The seat assembly 10 may be utilized as a vehicle seat assembly 10 for seating in a vehicle, such as an automobile, an aircraft, a watercraft, or any other seating environment. The seat assembly 10 includes a seat bottom 12, which may be adapted to be mounted for motor-driven adjustable translation in a fore and aft direction and in an up and down direction of a vehicle. The seat assembly 10 includes a seat back 14, which may be pivotally connected to the seat bottom 12 to extend generally upright relative to the seat bottom 12 for pivotal adjustment about an axis relative to the seat bottom 12.

The seat back 14 may include a head restraint 16 that may be configured to support the head of a seat occupant. The head restraint 16 may be disposed at the top of the seat back 14. The head restraint 16 may be unitary with the seat back 14 or may be a separate component that is adjustably positionable with respect to the top of the seat back 14. The seat bottom 12 may be configured to support a seat occupant. In a vehicular application, the seat bottom 12 may be mounted to a support surface, such as a vehicle floor. It should be understood that this is just one example of a seat configuration, and that other configurations could also be utilized.

In implementations, the seat assembly may include one or more sensors 20 that monitor and communicate data concerning the seat assembly 10 to one or more vehicle system controllers. In one example, at least one of the sensors 20 comprises an occupant sensor that can be used to detect the presence of an occupant on the seat assembly 14. In implementations, the presence of an occupant can be used to monitor whether or not a restraint structure 24, e.g., a seat belt mechanism, has been properly secured.

In implementations, each of the seat back 14 and seat bottom 12 include a foam cushion 22. The foam cushion 22 can be conventionally secured to a seat frame (not shown) by any method generally known in the art. Each foam cushion 22 may be one or more foam parts, joined together to form the seat component. For example, the seatback 14 foam cushion 22 may include a main seating portion and various bolster portions. The foam cushions 22 can have any suitable size and be formed from any suitable configuration of components. In implementations, the foam cushions 22 form a contoured shape, e.g., a concave shape, for a corresponding occupant seating surfaces, with the concavity of the foam cushions 22 improving occupant comfort and aesthetic styling of the seat assembly 10. The seat back 14 foam cushion 22 and the seat bottom 12 foam cushion 22 can independently comprise any suitable comfort foam material such as, but not limited to, a suitable resilient polymer, and can independently be formed in any suitable manner. For example, the foam cushions 22 may be formed of conventional polyurethane foam, soy-based foam, silicone, thermoplastic olefins, thermoplastic urethanes, and/or natural oil-based expanded polyurethanes, soy-based polyurethane, polymer fibers, non-woven polyester pads, latex foams and the like. The foam cushions 22 are formed of any suitable comfort material that provides soft resilience as the seat assembly is deflected during use when an occupant is in a seated position.

In implementations, a trim cover 26 may be disposed over or upon the cushions 22 and may cover the sensors 20. The trim cover 26 provides at least a portion of a visible exterior surface of the seat assembly 10. In implementations, the trim cover 26 may include a plurality of trim panels that may be assembled in any suitable manner, such as by stitching. The trim panels may be made of any suitable material or materials, such as fabric, leather, vinyl, or combinations thereof.

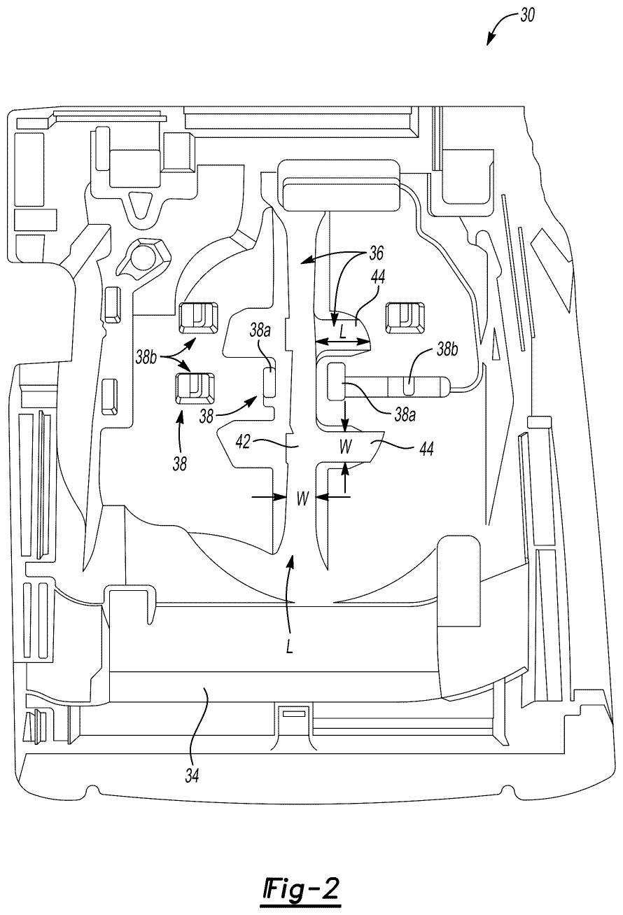

In implementations, a seat cushion comprises a foam body 30 as shown in FIGS. 2-4. The foam body 30 has a first surface 32 and a second surface 34 facing opposite the first surface 32. In one example, the first surface 32 comprises an A-side, outward facing contoured surface, and the second surface 34 is a B-side, inward facing surface. In implementations, the foam body 30 includes a plurality of protrusions 36 that extend outwardly of the second surface 34. In one example, the protrusions 36 comprise ribs, ridges, bands, or other similar structures.

In implementations, the foam body 30 also includes a plurality of cutouts 38 that are spaced from the plurality of protrusions 36. In one example, the cutouts 38 comprise open areas such as holes, slots, apertures, or other similar openings. In implementations, each cutout 38 extends through a thickness of the foam body 30 from the first surface 32 to the second surface 34. In implementations, cutouts 38 are associated with at least one of a sensor 20 and a trim component of the trim cover 26.

In one example, the plurality of protrusions 36 are formed at a central region of the second surface 34 as shown in FIG. 2.

In one example, one or more of the cutouts 38 are nested within the protrusions 36. For example, the cutouts 38 may be positioned between adjacent protrusions 36.

In one example, one or more of the cutouts 38 are located outboard of the protrusions 36.

In one example, the cutouts 38 comprise one or more sensor cutouts 38a and one or more trim component cutouts 38b.

In one example, the trim component cutouts 38b are located outward of the plurality of protrusions 36 and the sensor cutouts 38a.

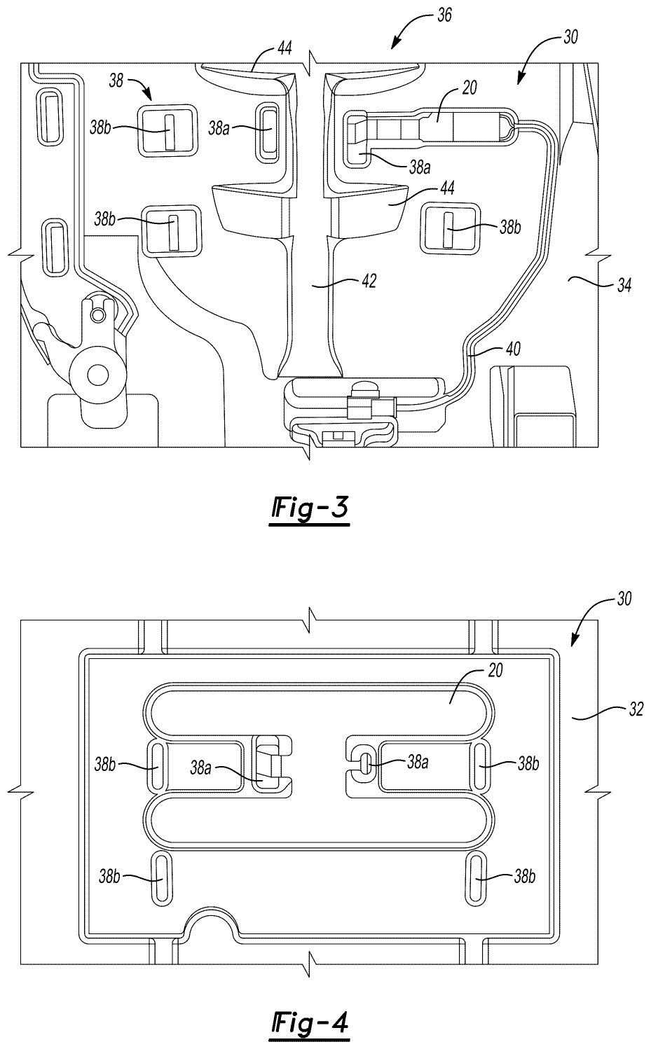

As shown in FIGS. 3-4, in implementations, at least one sensor 20 is supported by the foam body 30 via the sensor cutouts 38a. In one example, the sensor 20 is an occupant sensor as described above. An electrical connector assembly 40 may be used to connect the sensor 20 to one or more system controllers (not shown) in a known manner.

In one example, one or more portions of the trim cover 26 is attached to the foam body 30 via the trim component cutouts 38b. As such, the trim component cutouts 38b service as mounting points for securing portions of the trim to the seat assembly 10.

In implementations, the plurality of protrusions 36 comprise a plurality of ribs that extend outwardly of the second surface 34. In one example, the ribs comprise elongated bodies having a greater length than width.

In one example, the plurality of ribs comprise at least one first rib 42 and a plurality of second ribs 44 orientated transversely, e.g., non-parallel, to the first rib 42.

In one example, the first rib 42 and the plurality of second ribs 44 are each defined by a length L and a width W, wherein the length L is greater than the width W for each of the first rib 42 and the second ribs 44.

In one example, the length L of the first rib 42 is greater than lengths L of the second ribs 44.

In implementations, the plurality of second ribs 44 comprise at least two second ribs 44 intersecting the first rib 42. In one example, this configuration comprises a H-shape.

In one example, the two second ribs 44 are perpendicular to the first rib 42, and the two second ribs 44 are parallel to each other.

In implementations, the plurality of sensor cutouts 38a comprise at least first and second sensor cutouts, with the first sensor cutout being on one side of the first rib 42 and the second sensor cutout being on an opposite side of the first rib 42, and with the first and second sensor cutouts being positioned between the two second ribs 44.

In implementations, the plurality of trim cutouts 38b comprise at least two pairs of trim component cutouts positioned outboard of the first and second sensor cutouts 38a. For example, the sensor cutouts 38a are near a central region of the foam body 30 and the trim cutouts 38b are outward of the central region and adjacent to outer peripheral edges of the foam body 30. In one example, one pair of trim component cutouts 38b are on one side of the first rib 42 and the other pair of trim component cutouts 38b are on the opposite side of the first rib 42 as shown in FIG. 2.

The subject disclosure provides for a foam cushion design that achieves hip point, comfort, and durability requirements by providing a H-shaped protrusion, interior facing, side-coring of a rear seat cushion foam body. In implementations, the H-shape increases deflection to achieve the hip point target, while also still providing comfort.

In implementations, an apparatus comprises: a foam body comprising a first surface and a second surface facing opposite the first surface; a plurality of protrusions extending outwardly of at least one of the first surface and the second surface; and a plurality of cutouts spaced from the plurality of protrusions, each cutout extending through a thickness of the foam body from the first surface to the second surface, and wherein at least one cutout is associated with at least one of a sensor and a trim component.

In implementations, the apparatus may include any of the following either alone or in any combination. For example, the apparatus may further comprise where the first surface comprises a contoured surface, and wherein the plurality of protrusions are formed at a central region of the second surface.

For example, the apparatus may further comprise where the plurality of cutouts comprise one or more sensor cutouts and one or more trim component cutouts.

For example, the apparatus may further comprise where the one or more sensor cutouts are nested within the plurality of protrusions.

For example, the apparatus may further comprise where the one or more trim component cutouts are located outward of the plurality of protrusions and the one or more sensor cutouts.

For example, the apparatus may further comprise a trim cover, the trim cover attached to the foam body via the one or more trim component cutouts and at least one sensor supported by the foam body via the one or more sensor cutouts.

For example, the apparatus may further comprise where the plurality of protrusions comprise a plurality of ribs extending outwardly of the second surface.

For example, the apparatus may further comprise where the plurality of ribs comprise at least one first rib and a plurality of second ribs orientated transversely to the at least one first rib.

For example, the apparatus may further comprise where the at least one first rib and the plurality of second ribs are each defined by a length, a width, and a height, wherein the length is greater than the width and height for each of the at least one first rib and the plurality of second ribs.

For example, the apparatus may further comprise where the length of the at least one first rib is greater than lengths of the plurality of second ribs.

For example, the apparatus may further comprise where the plurality of second ribs comprise at least two second ribs intersecting the at least one first rib.

For example, the apparatus may further comprise where the at least two second ribs are perpendicular to the at least one first rib and the at least two second ribs are parallel to each other.

For example, the apparatus may further comprise where the plurality of cutouts comprise at least a first sensor cutout and a second sensor cutout, and wherein the first sensor cutout is on one side of the at least one first rib and the second sensor cutout is on an opposite side of the at least one first rib, and wherein the first sensor cutout and the second sensor cutout are positioned between the at least two second ribs.

For example, the apparatus may further comprise where the plurality of cutouts comprise at least two pairs of trim component cutouts positioned outboard of the first sensor cutout and the second sensor cutout, and wherein one pair of trim component cutouts are on the one side of the at least one first rib and the other pair of trim component cutouts are on the opposite side of the at least one first rib.

In implementations, a seat assembly comprises: at least one seat cushion comprising a foam body comprising a first surface and a second surface facing opposite the first surface; at least one sensor supported by the foam body; a trim cover assembly, the trim cover assembly covering the at least one sensor and the foam body; and wherein the foam body includes: a plurality of protrusions extending outwardly of the second surface; and a plurality of cutouts spaced from the plurality of protrusions, each cutout extending through a thickness of the foam body from the first surface to the second surface, and wherein at least one cutout is associated with at least one of the at least one sensor and the trim cover assembly.

In implementations, the seat assembly may include any of the following either alone or in any combination. For example, the seat assembly may further comprise where the plurality of cutouts comprise a plurality of sensor cutouts and a plurality of trim component cutouts, and wherein the at least one sensor is supported by the foam body via one or more sensor cutouts and wherein the trim cover assembly is attached to the foam body via one or more trim component cutouts.

For example, the seat assembly may further comprise where the plurality of protrusions comprise a plurality of ribs including at least one first rib and a plurality of second ribs orientated transversely to the at least one first rib.

For example, the seat assembly may further comprise where the at least one first rib and the plurality of second ribs are each defined by a length, a width, and a height, and wherein the length is greater than the width and height for each of the at least one first rib and the plurality of second ribs, and wherein the length of the at least one first rib is greater than lengths of the plurality of second ribs.

For example, the seat assembly may further comprise where the plurality of second ribs comprise at least two second ribs intersecting the at least one first rib.

For example, the seat assembly may further comprise where: the one or more sensor cutouts comprise at least a first sensor cutout and a second sensor cutout, and wherein the first sensor cutout is one side of the at least one first rib and the second sensor cutout is on an opposite side of the at least one first rib, and wherein the first sensor cutout and the second sensor cutout are positioned between the at least two second ribs; and the one or more trim component cutouts comprise at least two pairs of trim component cutouts positioned outboard of the first sensor cutout and the second sensor cutout, and wherein one pair of trim component cutouts are on the one side of the at least one first rib and the other pair of trim component cutouts are on the opposite side of the at least one first rib.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An apparatus comprising:
a foam body comprising a first surface and a second surface facing opposite the first surface;
a plurality of protrusions extending outwardly of at least one of the first surface and the second surface; and
a plurality of cutouts spaced from the plurality of protrusions, each cutout extending through a thickness of the foam body from the first surface to the second surface, and wherein at least one cutout is associated with at least one of a sensor and a trim component.

2. The apparatus of claim 1, wherein the first surface comprises a contoured surface, and wherein the plurality of protrusions are formed at a central region of the second surface.

3. The apparatus of claim 1, wherein the plurality of cutouts comprise one or more sensor cutouts and one or more trim component cutouts.

4. The apparatus of claim 3, wherein the one or more sensor cutouts are nested within the plurality of protrusions.

5. The apparatus of claim 3, wherein the one or more trim component cutouts are located outward of the plurality of protrusions and the one or more sensor cutouts.

6. The apparatus of claim 3, including a trim cover, the trim cover attached to the foam body via the one or more trim component cutouts and at least one sensor supported by the foam body via the one or more sensor cutouts.

7. The apparatus of claim 1, wherein the plurality of protrusions comprise a plurality of ribs extending outwardly of the second surface.

8. The apparatus of claim 7, wherein the plurality of ribs comprise at least one first rib and a plurality of second ribs orientated transversely to the at least one first rib.

9. The apparatus of claim 8, wherein the at least one first rib and the plurality of second ribs are each defined by a length, a width, and a height, wherein the length is greater than the width and height for each of the at least one first rib and the plurality of second ribs.

10. The apparatus of claim 9, wherein the length of the at least one first rib is greater than lengths of the plurality of second ribs.

11. The apparatus of claim 10, wherein the plurality of second ribs comprise at least two second ribs intersecting the at least one first rib.

12. The apparatus of claim 11, wherein the at least two second ribs are perpendicular to the at least one first rib and the at least two second ribs are parallel to each other.

13. The apparatus of claim 11, wherein the plurality of cutouts comprise at least a first sensor cutout and a second sensor cutout, and wherein the first sensor cutout is on one side of the at least one first rib and the second sensor cutout is on an opposite side of the at least one first rib, and wherein the first sensor cutout and the second sensor cutout are positioned between the at least two second ribs.

14. The apparatus of claim 13, wherein the plurality of cutouts comprise at least two pairs of trim component cutouts positioned outboard of the first sensor cutout and the second sensor cutout, and wherein one pair of trim component cutouts are on the one side of the at least one first rib and the other pair of trim component cutouts are on the opposite side of the at least one first rib.

15. A seat assembly comprising:
at least one seat cushion comprising a foam body comprising a first surface and a second surface facing opposite the first surface;
at least one sensor supported by the foam body;
a trim cover assembly, the trim cover assembly covering the at least one sensor and the foam body; and
wherein the foam body includes:
a plurality of protrusions extending outwardly of the second surface; and
a plurality of cutouts spaced from the plurality of protrusions, each cutout extending through a thickness of the foam body from the first surface to the second surface, and wherein at least one cutout is associated with at least one of the at least one sensor and the trim cover assembly.

16. The seat assembly of claim 15, wherein the plurality of cutouts comprise a plurality of sensor cutouts and a plurality of trim component cutouts, and wherein the at least one sensor is supported by the foam body via one or more sensor cutouts and wherein the trim cover assembly is attached to the foam body via one or more trim component cutouts.

17. The seat assembly of claim 16, wherein the plurality of protrusions comprise a plurality of ribs including at least one first rib and a plurality of second ribs orientated transversely to the at least one first rib.

18. The seat assembly of claim 17, wherein the at least one first rib and the plurality of second ribs are each defined by a length, a width, and a height, and wherein the length is greater than the width and height for each of the at least one first rib and the plurality of second ribs, and wherein the length of the at least one first rib is greater than lengths of the plurality of second ribs.

19. The seat assembly of claim 18, wherein the plurality of second ribs comprise at least two second ribs intersecting the at least one first rib.

20. The seat assembly of claim 19, wherein:
the one or more sensor cutouts comprise at least a first sensor cutout and a second sensor cutout, and wherein the first sensor cutout is one side of the at least one first rib and the second sensor cutout is on an opposite side of the at least one first rib, and wherein the first sensor cutout and the second sensor cutout are positioned between the at least two second ribs; and
the one or more trim component cutouts comprise at least two pairs of trim component cutouts positioned outboard of the first sensor cutout and the second sensor cutout, and wherein one pair of trim component cutouts are on the one side of the at least one first rib and the other pair of trim component cutouts are on the opposite side of the at least one first rib.
